(19) United States
(12) Patent Application Publication
(10) Pub. No.: US 2023/0038404 A1
(43) Pub. Date: Feb. 9, 2023

(54) FUSE

(71) Applicant: Pacific Engineering Corporation, Gifu (JP)

(72) Inventors: Keisuke Ohta, Gifu (JP); Jyunhyoku Yang, Gifu (JP)

(21) Appl. No.: 17/793,086

(22) PCT Filed: Dec. 10, 2020
(86) PCT No.: PCT/JP20/45997

§ 371 Date: Jul. 15, 2022

(30) Foreign Application Priority Data
Jan. 27, 2020 (JP) 2020-010747

(51) Int. Cl. H01H 85/175; H01H 85/22; H01H 85/044

(52) U.S. Cl. CPC H01H 85/175; H01H 85/22; H01H 85/044; H01M 50/543

(57) ABSTRACT

The invention of the present application provides a fuse that is easily attached directly or indirectly to a battery. A fuse fixed to a battery post BP or a coupling post of a base member coupled to the battery post BP includes: a fuse element including an input terminal fixed to the battery post BP or the coupling post, an external output terminal, and a fusion portion provided between the input terminal and the external output terminal; a housing including an exposure window through which the fusion portion is exposed, the housing accommodating the fuse element; and a cover member that covers the exposure window. The cover member includes a protruding portion protruding toward a battery BT side including the battery post BP or a base member side, and the protruding portion is able to abut on a part of the battery BT or a part of the base member.

### PRIORITY CLAIM

This application is a U.S. national phase of International Patent Application No. PCT/JP2020/045997 filed Dec. 10, 2020, which claims the benefit of priority from Japan Patent Application No. 2020-010747 filed Jan. 27, 2020, the contents of which are incorporated by reference.

### FIELD OF THE INVENTION

The invention of the present application relates to a fuse mainly used in an automobile electric circuit or the like.

### BACKGROUND OF THE INVENTION

Conventionally, fuses have been used to protect an electric circuit mounted on an automobile or the like and various electrical components connected to the electric circuit. Specifically, if an unintended overcurrent flows in the electric circuit, a fusion portion of a fuse element built in the fuse fuses due to heat generated by the overcurrent to protect various electrical components from excessive current flowing therethrough.

There are various types of fuses depending on the application. For example, the fuse described in Patent Literature 1 is configured as a fuse unit so as to be easily attached to an in-vehicle battery. Specifically, the fuse unit connects the in-vehicle battery and an electric wire that supplies power to various electrical components, and includes an input terminal connected to a battery post of the battery, a plurality of external terminals that connect external electric wires, an electric circuit unit that distributes power from the input terminal to each external terminal, and a plurality of fusion portions formed in the electric circuit unit.

However, in this fuse unit, since the plurality of fusion portions are integrally formed with the electric circuit unit, it is inconvenient to change or replace the entire fuse unit when the rating of the fusion portion is changed or when a part of the fusion portion is fused. Therefore, there is a case where a mode in which the fusion portions are independent, that is, a mode in which fuses are individually attached to the battery instead of the fuse unit is adopted. However, since the fuse is smaller than the fuse unit, there is a problem that when the fuse is attached directly to the battery or indirectly to the battery via a base member, a position and a posture of the fuse are displaced and it is difficult to attach the fuse.

### CITATIONS LIST

### Patent Literature

Patent Literature 1: JP 2005-339965 A

### SUMMARY OF THE INVENTION

### Technical Problem

Therefore, the invention of the present application provides a fuse that is easily attached directly or indirectly to a battery.

### Solutions to Problem

In order to solve the above problem, according to the invention of the present application, there is provided a fuse fixed to a battery post or a coupling post of a base member coupled to the battery post, the fuse including: a fuse element including an input terminal fixed to the battery post or the coupling post, an external output terminal, and a fusion portion provided between the input terminal and the external output terminal; a housing including an exposure window through which the fusion portion is exposed, the housing accommodating the fuse element; and a cover member that covers the exposure window, in which the cover member includes a protruding portion protruding toward a battery side including the battery post or the base member side, and in which the protruding portion is able to abut on a part of the battery or a part of the base member.

According to the above feature, the protruding portion of the fuse protrudes toward the battery side or the base member side, and is configured to be able to abut on a part of the battery or a part of the base member when the fuse is attached to the battery or the base member. Therefore, when the fuse is attached, the position and posture of the fuse are not displaced by the protruding portion, so that the fuse can be easily attached.

Further, in the fuse of the invention of the present application, the cover member includes at least two of the protruding portions, and the protruding portions are separated from each other.

According to the above feature, since the protruding portion abuts on a part of the battery or a part of the base member at two locations, the position and posture of the fuse are more stable when the fuse is attached to the battery or the base member.

Further, in the fuse of the invention of the present application, the external output terminal and the fusion portion extend downward from the input terminal.

According to the above feature, since the external output terminal and the fusion portion extend downward from the input terminal, the external output terminal and the fusion portion have a substantially inverted L shape, and when the fuse is attached to the base member or the battery, the fuse does not protrude laterally and fits well.

Further, in the fuse of the invention of the present application, the cover member includes a locking claw that engages with a part of the housing.

According to the above feature, the cover member is hardly detached from the housing.

### Advantageous Effects of Invention

As described above, according to the fuse of the invention of the present application, it is easy to directly or indirectly attach the fuse to the battery.

### BRIEF DESCRIPTION OF THE DRAWINGS

Preferred and alternative examples of the present invention are described in detail below with reference to the following drawings.

FIG. 1 is an overall perspective view of a fuse element of a fuse of the invention of the present application.

FIG. 2 is an overall perspective view of a housing accommodating the fuse element of the fuse of the invention of the present application.

FIG. 3(a) is a plan view of a housing of the fuse of the invention of the present application, FIG. 3(b) is a side view of the housing, FIG. 3(c) is a front view of the housing, and FIG. 3(d) is a rear view of the housing.

FIG. 4(a) is an overall perspective view of a cover member of the fuse of the invention of the present application, FIG. 4(b) is a plan view of the cover member, FIG. 4(c) is a front view of the cover member, and FIG. 4(d) is a rear view of the cover member.

FIG. 5(a) is an overall perspective view of the fuse before the cover member is attached, FIG. 5(b) is an overall perspective view of the fuse after the cover member is attached, and FIG. 5(c) is a rear view of the fuse after the cover member is attached.

FIG. 6(a) is a perspective view illustrating a state in which the fuse is attached to a base member attached to a battery, and FIG. 6(b) is a plan view of the state.

FIG. 7(a) is a perspective view of a state in which the fuse is attached to the base member, FIG. 7(b) is a side view of the state, and FIG. 7(c) is a plan view of the state.

FIG. 8(a) is a perspective view illustrating a state in which the fuse is attached to a battery post of the battery, FIG. 8(b) is a plan view of the state, and FIG. 8(c) is a plan view of a state in which the fuse is attached to the battery post.

### REFERENCE SIGNS LIST

100 fuse element
110 input terminal
120 external output terminal
130 fusion portion
200 housing
230 exposure window
300 cover member
340 protruding portion
400 fuse
500 base member
510 coupling post
BP battery post
BT battery

### DETAILED DESCRIPTION OF THE PREFERRED EMBODIMENT

Hereinafter, each embodiment of the invention of the present application will be described with reference to the drawings. The shape, material, and the like of each member of a fuse in the embodiment described below are merely examples, and are not limited thereto.

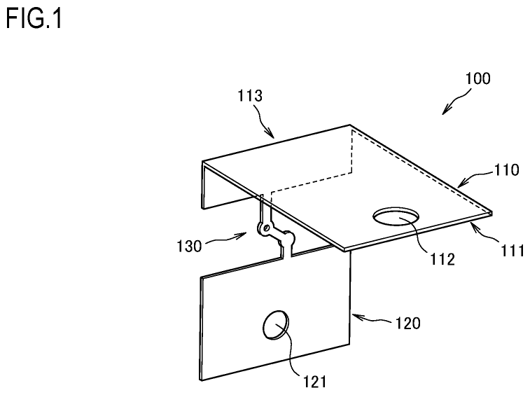

In FIG. 1, a fuse element 100 of a fuse of the invention of the present application will be described. FIG. 1 is an overall perspective view of the fuse element 100.

The fuse element 100 is formed by punching a flat plate material made of a conductive metal such as copper or an alloy thereof into a shape as illustrated in FIG. 1 with a press machine or the like and bending the plate material, and includes an input terminal 110 fixed to a battery post or a coupling post of a base member coupled to the battery post, an external output terminal 120 connecting an external electric wire, and a fusion portion 130 provided between the input terminal 110 and the external output terminal 120. The fusion portion 130 has a linear fusion portion in which a small hole is provided in the plate material constituting the fuse element 100 and a width is locally narrowed, and when an unintended overcurrent flows in an electric circuit or the like, the fusion portion 130 generates heat and fuses to cut off the overcurrent.

Note that the fusion portion 130 is not limited to being formed of a linear fusion portion having a narrow width, and any configuration can be adopted such as locally disposing a metal material which is likely to be fused on the plate material constituting the fuse element 100 as long as, when an unintended overcurrent flows in an electric circuit or the like, the fusion portion 130 generates heat and fuses to cut off the overcurrent. The fuse element 100 is provided with the fusion portion 130 and one external output terminal 120 coupled to the fusion portion 130, but is not limited thereto, and the fusion portion 130 and two or more external output terminals 120 coupled to the fusion portion 130 may be provided.

In addition, the input terminal 110 includes a coupling hole 112 through which the battery post or the coupling post of the base member is inserted on a distal end 111 side, and a proximal end 113 side is bent downward by approximately 90 degrees. The fusion portion 130 extends downward from the bent proximal end 113, and the external output terminal 120 coupled to the fusion portion 130 also extends downward. As described above, since the fusion portion 130 and the external output terminal 120 extend downward from the input terminal 110, the entire fuse element 100 has an inverted L shape in a side view. The external output terminal 120 includes a coupling hole 121 to which a connection terminal for connecting an external electric wire can be fixed.

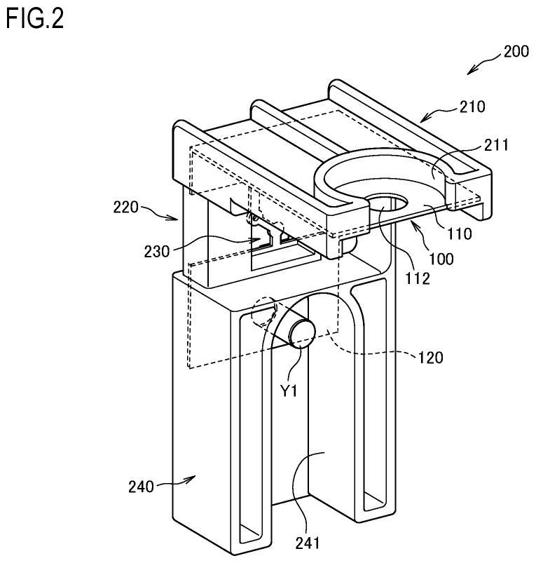

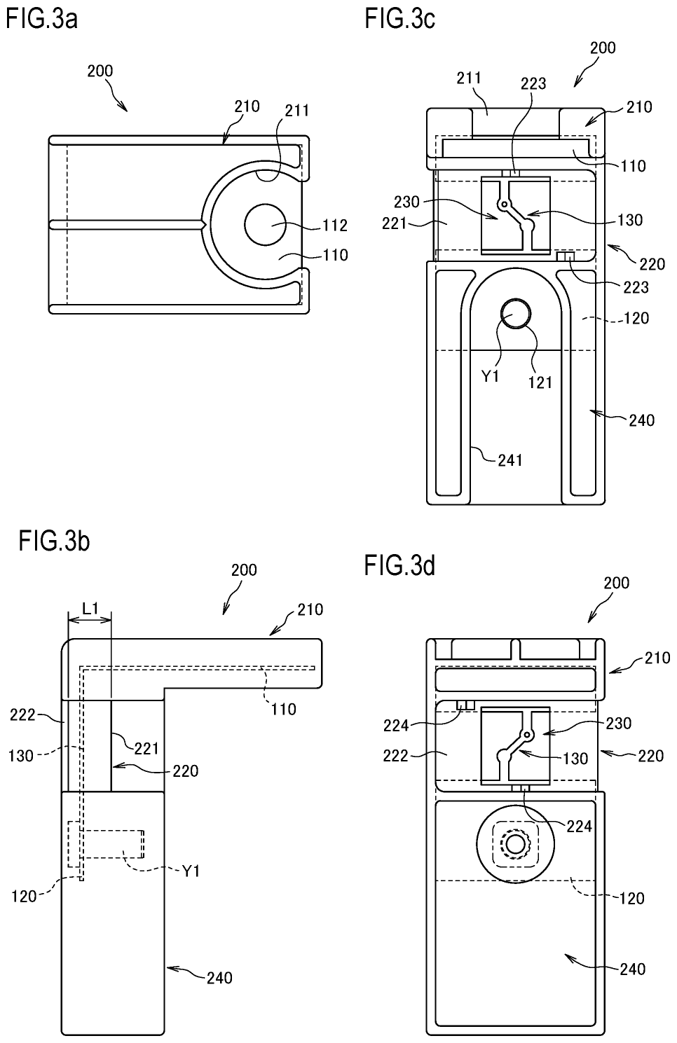

Next, a state in which the fuse element 100 is accommodated in the housing 200 will be described with reference to FIGS. 2 and 3. FIG. 2 is an overall perspective view of the housing 200 accommodating the fuse element 100, FIG. 3(a) is a plan view of the housing 200, FIG. 3(b) is a side view of the housing 200, FIG. 3(c) is a front view of the housing 200, and FIG. 3(d) is a rear view of the housing 200.

The housing 200 is entirely made of an insulating synthetic resin, and is configured to be capable of accommodating the fuse element 100 therein. Specifically, the housing 200 includes an input-side housing 210 that covers the input terminal 110 of the fuse element 100, a fusion-portion housing 220 including an exposure window 230 that exposes the fusion portion 130, and an output-side housing 240 that covers the external output terminal 120. The input-side housing 210 has a recess 211 around the coupling hole 112 so that the coupling hole 112 of the input terminal 110 is exposed.

The exposure window 230 of the fusion-portion housing 220 has a substantially quadrangular shape, and penetrates the fusion-portion housing 220 from the front side to the back side. Therefore, the fusion portion 130 accommodated in the fusion-portion housing 220 is exposed from the exposure window 230 to the front side and the back side. Further, a thickness L1 of the fusion-portion housing 220 is smaller than the other portions of the housing 200 so that a cover member described later can be easily fitted. Further, recessed engagement portions 223 with which locking claws of the cover member described later are engaged are provided on a front surface 221 of the fusion-portion housing 220. Similarly, recessed engagement portions 224 with which locking claws of the cover member described later are engaged are also provided on a back surface 222 of the fusion-portion housing 220.

In addition, the output-side housing 240 accommodates the external output terminal 120 in a state where a cylindrical connection terminal Y1 penetrates the coupling hole 121 of the external output terminal 120, and a recess 241 recessed in a substantially U shape is provided around the connection terminal Y1 so that the distal end side of the connection terminal Y1 protrudes outward from the output-side housing 240.

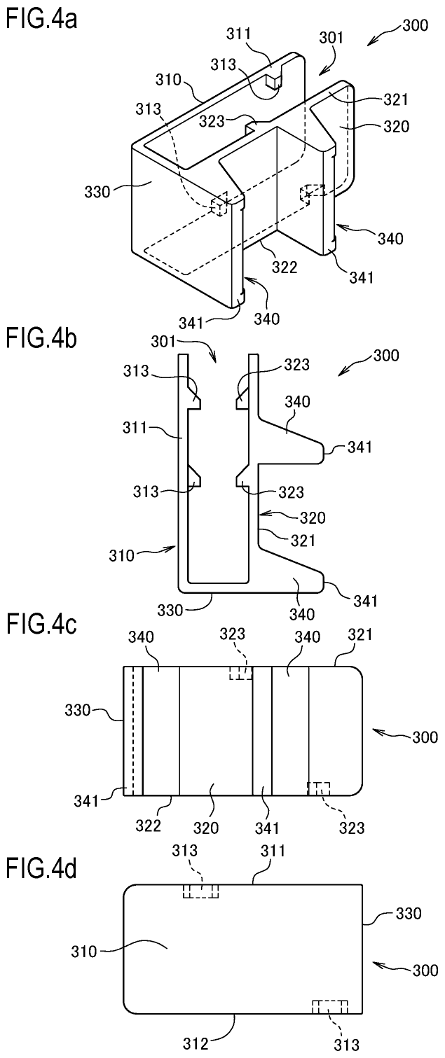

Next, a cover member 300 that covers the exposure window 230 of the housing 200 will be described with reference to FIG. 4. FIG. 4(a) is an overall perspective view of the cover member 300, FIG. 4(b) is a plan view of the cover member 300, FIG. 4(c) is a front view of the cover member 300, and FIG. 4(d) is a rear view of the cover member 300.

As illustrated in FIG. 4, the cover member 300 is entirely formed of a transparent or translucent synthetic resin, and includes a flat plate-like side wall 310 and a side wall 320, and a coupling wall 330 coupling the side wall 310 and the side wall 320 in parallel to each other. Further, on the opposite side of the coupling wall 330, the side wall 310 and the side wall 320 are not coupled to each other and are released, and this released portion serves as an insertion port 301 for inserting and attaching the cover member 300 to the fusion-portion housing 220 of the housing 200 as described later. Each of the side wall 310 and the side wall 320 of the cover member 300 has a size capable of covering the entire exposure window 230 of the fusion-portion housing 220.

In addition, two protruding portions 340 protruding outward are formed on the side wall 320, and the protruding portions 340 are separated from each other. In addition, the protruding portions 340 have a mountain shape in a plan view, and distal ends 341 of the protruding portions 340 have the same height. Further, locking claws 313 are alternately arranged on inner sides of an upper end 311 and a lower end 312 of the side wall 310. Similarly, locking claws 323 are alternately arranged on inner sides of an upper end 321 and a lower end 322 of the side wall 320. As will be described later, when the cover member 300 is attached to the fusion-portion housing 220 of the housing 200, the locking claws 313 of the side wall 310 of the cover member 300 are engaged with the engagement portions 224 on the back surface 222 side of the fusion-portion housing 220, and the locking claws 323 of the side wall 320 of the cover member 300 are engaged with the engagement portions 223 on the front surface 221 side of the fusion-portion housing 220, so that the cover member 300 is hardly detached from the housing 200.

Note that the entire cover member 300 is formed of a transparent or translucent synthetic resin, but the present invention is not limited thereto, and the cover member 300 may be formed of any synthetic resin of any color. The two protruding portions 340 are formed on the side wall 320 of the cover member 300, but the present invention is not limited thereto, and only one protruding portion 340 may be formed at the center of the side wall 320. Further, three or more protruding portions 340 may be formed on the side wall 320 of the cover member 300.

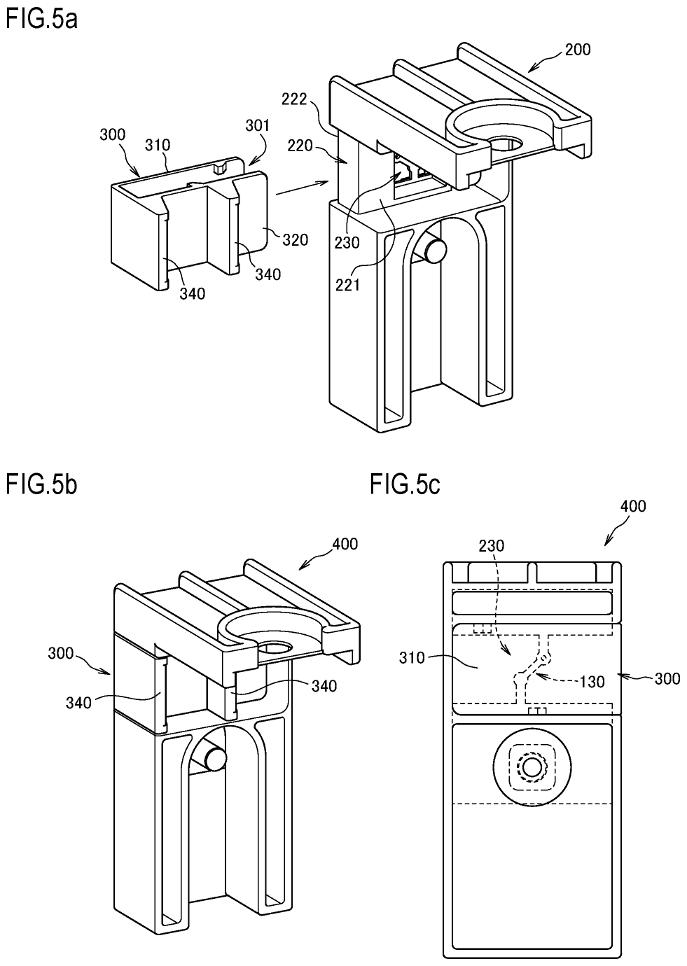

Next, a fuse 400 in a state where the cover member 300 is attached to the housing 200 accommodating the fuse element 100 will be described with reference to FIG. 5. FIG. 5(a) is an overall perspective view of the fuse 400 before the cover member 300 is attached, FIG. 5(b) is an overall perspective view of the fuse 400 after the cover member 300 is attached, and FIG. 5(c) is a rear view of the fuse 400 after the cover member 300 is attached.

As illustrated in FIG. 5(a), the insertion port 301 of the cover member 300 is inserted into the fusion-portion housing 220 from the side of the fusion-portion housing 220 of the housing 200 accommodating the fuse element 100. Then, as illustrated in FIGS. 5(b) and 5(c), the front surface 221 and the back surface 222 of the fusion-portion housing 220 are sandwiched between the side wall 320 and the side wall 310 of the cover member 300, and the exposure window 230 of the fusion-portion housing 220 is covered with the side wall 310 and the side wall 320 of the cover member 300. As illustrated in FIG. 5(b), in the fuse 400 to which the cover member 300 is attached, the protruding portions 340 of the cover member 300 protrude toward the inside of the fuse 400. Further, as illustrated in FIG. 5(c), from the back side of the fuse 400, the fusion portion 130 in the exposure window 230 can be visually observed through the transparent or translucent side wall 310 of the cover member 300. Therefore, whether or not the fusion portion 130 is fused can be visually confirmed through the cover member 300.

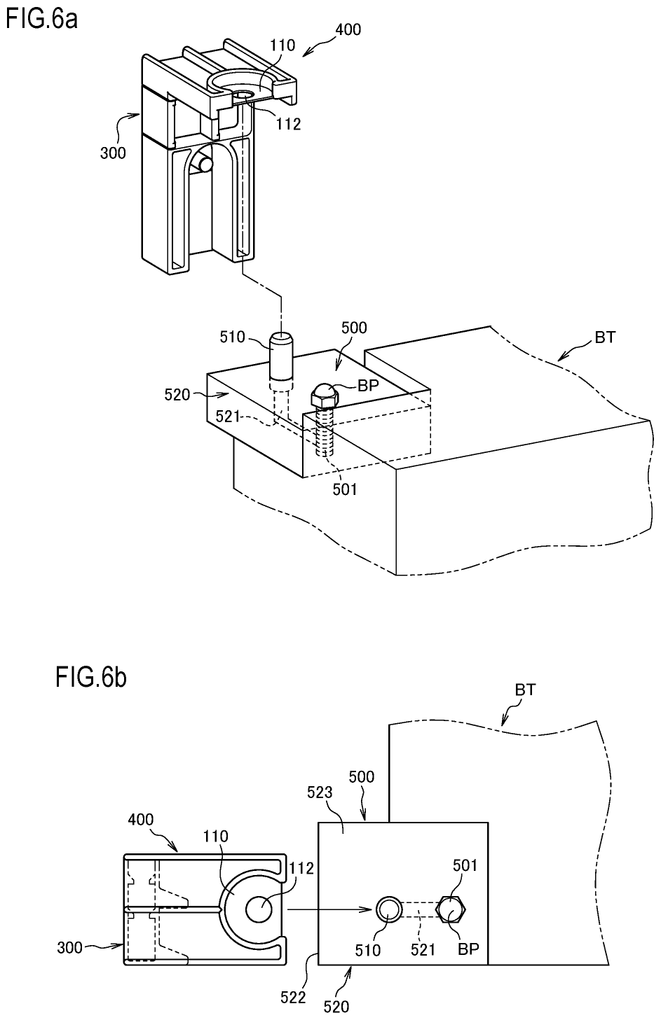

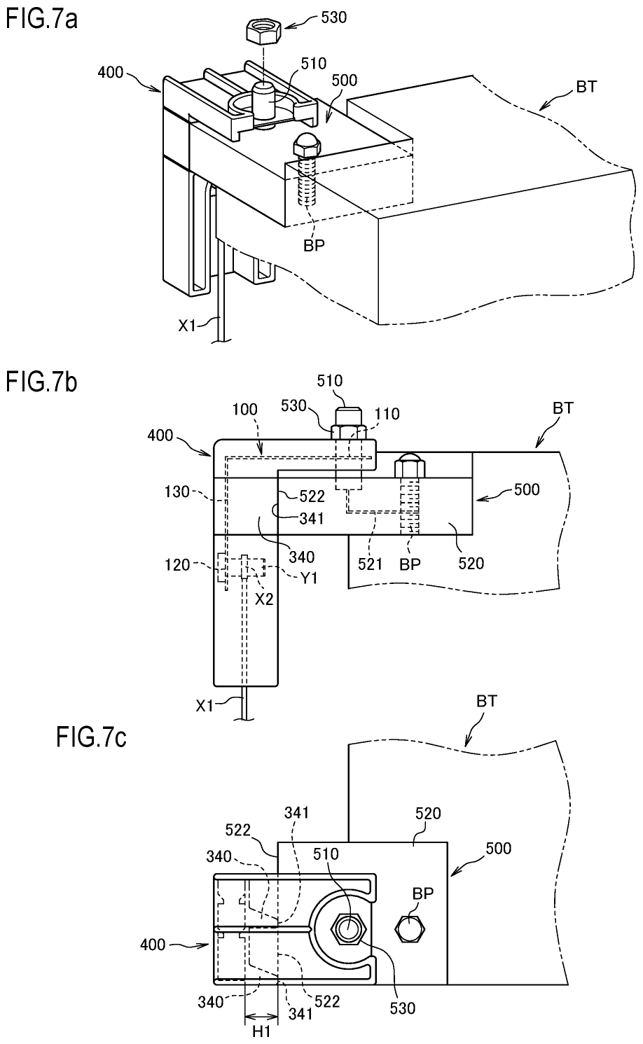

Next, a usage mode of the fuse 400 will be described with reference to FIGS. 6 and 7. FIG. 6(a) is a perspective view illustrating a state in which the fuse 400 is attached to a base member 500 attached to a battery BT, FIG. 6(b) is a plan view of the state, FIG. 7(a) is a perspective view of a state in which the fuse 400 is attached to the base member 500, FIG. 7(b) is a side view of the state, and FIG. 7(c) is a plan view of the state.

First, as illustrated in FIG. 6(a), the base member 500 is attached to a metal battery post BP provided in a part of the in-vehicle battery BT. The base member 500 includes a metal coupling post 510, and has a shape corresponding to the fuse 400 so that the fuse 400 is attached. The base member 500 is conventionally used, and supplies power from the battery post BP to the coupling post 510. A main body portion 520 of the base member 500 builds a connection hole 501 through which the battery post BP is inserted and electrically connected, and a circuit 521 that electrically connects the battery post BP connected to the connection hole 501 and the coupling post 510. The base member 500 is used when the fuse 400 cannot be directly attached to the battery post BP. For example, since the shape of the fuse 400 and the shape around the battery post BP are greatly different, the base member 500 is used when it is difficult to fix the position and posture of the fuse 400 when the fuse 400 is directly connected to the battery post BP.

When the fuse 400 is attached to the coupling post 510 of the base member 500, as illustrated in FIG. 6, the fuse 400 is attached from above the base member 500 so that the coupling post 510 of the base member 500 is inserted into the coupling hole 112 of the input terminal 110 of the fuse 400. The base member 500 includes a flat upper surface portion 523 and a side surface portion 522 extending downward from the upper surface portion 523. Therefore, the input terminal 110 of the fuse 400 can be placed on the upper surface portion 523 of the base member 500, and the periphery of the cover member 300 of the fuse 400 can be attached so as to be fitted to the side surface portion 522 of the base member 500.

Next, as illustrated in FIG. 7, a fixing member 530 such as a bolt is screwed to the coupling post 510 of the base member 500 penetrating the coupling hole 112 of the fuse 400 from above to fix the coupling hole 112 of the fuse 400 so as not to come off from the coupling post 510. Then, the fuse 400 is fixed to the base member 500. As illustrated in FIG. 7(b), since the connection terminal Y1 of the fuse 400 protrudes inward, a connection terminal X2 of an external electric wire X1 can be fixed to the connection terminal Y1. Then, the power supplied from the battery post BP of the battery BT is transmitted from the circuit 521 built in the base member 500 to the coupling post 510, and is transmitted from the input terminal 110 of the fuse element 100 of the fuse 400 fixed to the coupling post 510 to the external output terminal 120. Further, the power is transmitted from the external output terminal 120 of the fuse 400 to the electric wire X1 via the connection terminal Y1, and is supplied to various electric components connected to the electric wire X1. If an unintended overcurrent flows in the electric circuit, the fusion portion 130 of the fuse 400 fuses due to heat generated by the overcurrent to protect various electrical components from excessive current flowing therethrough.

Here, as illustrated in FIG. 7(c), when the fuse 400 is attached to the base member 500, the protruding portions 340 protruding toward the inside of the fuse 400 abut on the side surface portion 522 of the main body portion 520 of the base member 500. That is, the protruding portions 340 of the fuse 400 protrude toward the base member 500, and are configured to be able to abut on a part of the base member 500 when the fuse 400 is attached to the base member 500. Therefore, when the fuse 400 is attached to the base member 500, the position and posture of the fuse 400 are not displaced by the protruding portions 340, so that the fuse 400 can be easily attached. For example, when the fixing member 530 is screwed to attach the fuse 400 to the base member 500, the protruding portions 340 of the fuse 400 abut on a part of the base member 500, so that the fuse 400 is prevented from rotating around the coupling post 510 along with the rotation of the fixing member 530.

As illustrated in FIG. 7(c), since the fuse 400 includes the two protruding portions 340 separated from each other, the protruding portions 340 abut on a part of the base member 500 at two locations, and thus, the position and posture of the fuse 400 are more stable when the fuse 400 is attached to the base member 500. For example, the fuse 400 is effectively prevented from rotating clockwise and counterclockwise about the coupling post 510 along with the rotation of the fixing member 530. The fuse 400 includes the two protruding portions 340 separated from each other, but the present invention is not limited thereto, and the fuse 400 may include only one protruding portion 340, or the fuse 400 may include three or more protruding portions 340.

As illustrated in FIGS. 7(b) and 7(c), in a state where the fuse 400 is attached to the base member 500, the distal ends 341 of the protruding portions 340 of the fuse 400 abut on the side surface portion 522 of the base member 500, but the present invention is not limited thereto, and there may be a gap between the distal ends 341 of the protruding portions 340 of the fuse 400 and the base member 500. Even if there is a gap between the protruding portions 340 and the base member 500, if the protruding portions 340 can abut on a part of the base member 500 when the fuse 400 is attached to the base member 500 and the position and posture of the fuse 400 are displaced, the position and posture of the fuse 400 are not further displaced, so that the fuse 400 can be easily attached. The protruding portions 340 of the fuse 400 abut on the side surface portion 522 of the base member 500. However, the present invention is not limited to this. As long as the protruding portions 340 can abut on the side surface portion 522, the protruding portions 340 may be configured to be able to abut on any location of the base member 500 in addition to the side surface portion 522.

The protruding portions 340 of the fuse 400 of the invention of the present application have a height H1 that protrudes toward the base member 500 and can abut on a part of the base member 500. The height H1 of the protruding portions 340 can be set to any height as long as the protruding portions 340 can abut on a part of the base member 500, that is, the protruding portions 340 abut on the base member 500 in a state where the fuse 400 is attached to the base member 500 or the protruding portions 340 abut on a part of the base member 500 when the position and posture of the fuse 400 are displaced even if there is a gap between the protruding portions 340 and the base member 500. For example, when the side surface portion 522 of the base member 500 further extends toward the fuse 400 than in the state illustrated in FIG. 7, the height H1 of the protruding portions 340 may be lowered, and when the side surface portion 522 of the base member 500 is further away from the fuse 400, the height H1 of the protruding portions 340 may be raised.

In addition, since the protruding portions 340 of the fuse 400 of the invention of the present application are provided on the cover member 300, the manufacturing cost due to the shape change of the protruding portions 340 can be minimized. Specifically, also in the conventional fuse, the cover member 300 is made of a transparent or translucent synthetic resin and is manufactured separately from the housing 200 in order to ensure the visibility of the fusion portion 130 disposed inside. Therefore, in the invention of the present application, when the shape of the protruding portions 340 is changed by providing the protruding portions 340 in the cover member 300, only the shape of the cover member 300 needs to be changed, and the design of the entire housing 200 is not affected. As a result, in the invention of the present application, an increase in manufacturing and design cost of the entire fuse 400 due to the shape change of the protruding portions 340 can be minimized.

As illustrated in FIG. 7(b), since the external output terminal 120 and the fusion portion 130 extend downward from the input terminal 110, the fuse 400 of the invention of the present application has a substantially inverted L shape, and when the fuse 400 is attached to the base member 500 or the battery BT, the fuse 400 does not protrude laterally and fits well.

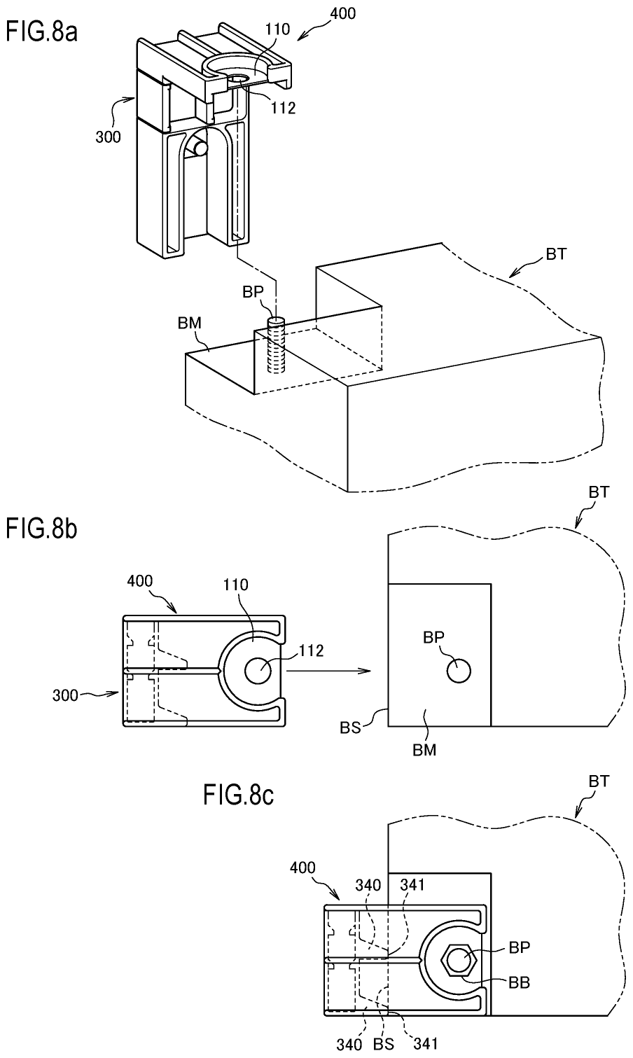

In FIGS. 6 and 7, the fuse 400 is indirectly connected to the battery post BP of the battery BT via the base member 500, but the present invention is not limited thereto. As long as the shape of the fuse 400 corresponds to the shape around the battery post BP, the fuse 400 may be directly connected to the battery post BP without the base member 500 as illustrated in FIG. 8. FIG. 8(a) is a perspective view illustrating a state in which the fuse 400 is attached to the battery post BP of the battery BT, FIG. 8(b) is a plan view of the state, and FIG. 8(c) is a plan view of a state in which the fuse 400 is attached to the battery post BP.

As illustrated in FIGS. 8(a) and 8(b), the fuse 400 is attached to an attachment surface BM around the battery post BP so that the battery post BP of the battery BT is inserted into the coupling hole 112 of the input terminal 110 of the fuse 400. The attachment surface BM is a flat surface formed by cutting out a side surface portion BS near the corner of the battery BT, and the battery post BP protrudes upward from the attachment surface BM. Therefore, the input terminal 110 of the fuse 400 can be placed on the attachment surface BM, and the periphery of the cover member 300 of the fuse 400 can be mounted so as to be fitted to the side surface portion BS of the battery BT. Next, as illustrated in FIG. 8(c), a fixing member BB such as a bolt is screwed from above to the battery post BP penetrating the coupling hole 112 of the fuse 400, and the coupling hole 112 of the fuse 400 is fixed so as not to come off from the battery post BP. Then, the fuse 400 is fixed to the battery post BP.

As illustrated in FIG. 8(c), when the fuse 400 is attached to the battery post BP, the protruding portions 340 protruding toward the inside of the fuse 400 abut on the side surface portion BS of the battery BT. Therefore, since the position and posture of the fuse 400 are not displaced by the protruding portions 340, the fuse 400 can be easily attached to the battery post BP. For example, when the fixing member BB is screwed to attach the fuse 400 to the battery post BP, the protruding portions 340 of the fuse 400 abut on a part of the battery BT, so that the fuse 400 is prevented from rotating around the battery post BP along with the rotation of the fixing member BB.

As illustrated in FIG. 8(c), in a state where the fuse 400 is attached to the battery post BP, the protruding portions 340 of the fuse 400 abut on the side surface portion BS of the battery BT, but the present invention is not limited thereto, and there may be a gap between the protruding portions 340 of the fuse 400 and the battery BT. Even if there is a gap between the protruding portions 340 and the battery BT, if the protruding portions 340 can abut on a part of the battery BT when the fuse 400 is attached to the battery post BP and the position and posture of the fuse 400 are displaced, the position and posture of the fuse 400 are not further displaced, so that the fuse 400 can be easily attached. The protruding portions 340 of the fuse 400 abut on the side surface portion BS of the battery BT. However, the present invention is not limited to this. As long as the protruding portions 340 can abut on the side surface portion BS, the protruding portions 340 may be configured to be able to abut on any location of the battery BT in addition to the side surface portion BS.

The fuse of the invention of the present application is not limited to the above embodiment, and various modifications and combinations are possible within the scope of the claims and the scope of the embodiment, and these modifications and combinations are also included in the scope of rights.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A fuse fixed to a battery post or a coupling post of a base member coupled to the battery post, the fuse comprising:
a fuse element including an input terminal fixed to the battery post or the coupling post, an external output terminal, and a fusion portion provided between the input terminal and the external output terminal;
a housing including an exposure window through which the fusion portion is exposed, the housing accommodating the fuse element; and
a cover member that covers the exposure window,
wherein the cover member includes a protruding portion protruding toward a battery side including the battery post or the base member side, and
wherein the protruding portion is able to abut on a part of the battery or a part of the base member.

2. The fuse according to claim 1,
wherein the cover member includes at least two of the protruding portions, and
wherein the protruding portions are separated from each other.

3. The fuse according to claim 1, wherein the external output terminal and the fusion portion extend downward from the input terminal.

4. The fuse according to claim 1, wherein the cover member includes a locking claw that engages with a part of the housing.

5. The fuse according to claim 2, wherein the external output terminal and the fusion portion extend downward from the input terminal.

6. The fuse according to claim 2, wherein the cover member includes a locking claw that engages with a part of the housing.

7. The fuse according to claim 3, wherein the cover member includes a locking claw that engages with a part of the housing.
